(19) United States
(12) Patent Application Publication
(10) Pub. No.: US 2009/0207529 A1
(43) Pub. Date: Aug. 20, 2009

(54) Flexible printed cable, head stack assembly with the same and manufacturing method thereof

(75) Inventor: MingGao Yao, Dongguan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K) Ltd., Hong Kong (CN)

(21) Appl. No.: 12/078,609

(22) Filed: Apr. 2, 2008

(30) Foreign Application Priority Data
Feb. 15, 2008 (CN) 200810005899.0

(51) Int. Cl. G11B 21/16

(52) U.S. Cl. 360/245.9

(57) ABSTRACT

A HSA includes a plurality of HGAs and an FPC. The FPC includes a connector for connecting with a control system, a voltage trace and a ground trace. A common voltage end of the voltage trace has a plurality of first voltage pads and a plurality of second voltage pads arranged adjacent to the corresponding first voltage pads respectively and electrically isolated from the respective first voltage pads. Each of the second voltage pads connects with the micro-actuator of the corresponding HGA. A common ground end of the ground trace has a plurality of micro-actuator ground pads, each of which connects with a micro-actuator of the corresponding HGA. The second voltage pads and the corresponding first voltage pads are connected with each other after the micro-actuator are tested. The invention also discloses a manufacturing method of the HSA.

### FIELD OF THE INVENTION

The present invention relates to an information recording disk drive unit, and more particularly to a flexible printed cable (FPC) of the disk drive unit, a head stack assembly (HSA) with the FPC and its manufacturing method.

### BACKGROUND OF THE INVENTION

Disk drives are information storage devices that use magnetic media to store data. FIG. 1 is a schematic view of a typical hard disk drive (HDD). As shown in FIG. 1, the HDD 1 includes at least one disk 101, a spindle motor 102 for spinning the disk 101, a voice coil motor (VCM) 108 and a head stack assembly (HSA) 200. The HSA 200 connects to a printed circuit board used for controlling the HSA and sliders through the FPC 109. All the components above-mentioned are located in a housing 111 of the HDD.

FIG. 2 illustrates the detailed structure of the HSA 200 shown in FIG. 1. Referring to FIGS. 1-2, the HSA 200 includes a plurality of head gimbal assemblies (HGA) 100 formed at one end thereof. One end of each HGA 100 connects with an actuator arm 104, and the other end has a slider 103 formed thereon. The slider 103 dynamically floats over the spinning disk 101 to read data from the disk 101 or write data to the disk 101 using the read/write head (not shown in the figure) incorporated therein. The other end of the HSA 200 provides a fantail voice coil 107. The actuator arm 104 and the fantail voice coil 107 are mounted on the housing 111 of the HDD via a bearing 112. The voice coil motor 108 is used for controlling the voice coil 107 to drive the HSA 200 to rotate. One end of the FPC 109 connects to a printed circuit board (not shown) through a connector 110, and the other end partially connects with an output end 127 of a preamplifier 121, an input end 128 of which connects with a tail portion of flexible cables 126 at the position 129 and electrically connects with the sliders 103 through the flexible cables 126 (referring to FIG. 5). The preamplifier 121 is used to amplify the electrical signals from the sliders 103.

FIG. 3 shows the structure of the HGA 100 shown in FIG. 2. FIG. 4 is a partially enlarged view of the HGA 100 shown in FIG. 3. FIG. 5 shows the tail portion of one flexible cable connecting with the HGA 100 and the flexible cable 126. As shown in the figures, the HGA 100 includes a base plate 114, a hinge 115, a load beam 116 and a flexure 117, which are assembled together to form a suspension 113. The suspension 113 carries a micro-actuator 105 and a slider 103 thereon. The micro-actuator 105 is used to fine tune the position of the slider 103, while the aforesaid voice coil motor 108 is used to make larger adjustments to the position of the slider 103. The micro-actuator 105 electrically connects with inner suspension traces 119 through several electrical bonding balls 124, and the slider 103 electrically connects with outer suspension traces 118 through several electrical bonding balls 125. The inner suspension traces 119 and outer suspension traces 118 further electrically connect with a plurality of electrical bonding pads 120 on the flexure 117 which electrically connect with the FPC 109 and the preamplifier 121 through the flexure cable and its tail portion 126 (referring to FIG. 2 and FIG. 5). Thus control signals from external control system (not shown) are able to control the slider 103 and the micro-actuator 105 via the printed circuit board, the connector 110 connecting with the printed circuit board, the FPC 109, the preamplifier 121 of the FPC 109, the flexible cable 126 and the tail portion of the flexible cable 126, the inner and outer suspension traces 119,118 connecting with the flexible cable 126.

FIG. 6a partially illustrates the electrical connection relationship of the above-mentioned FPC 109, the preamplifier 121 and the tail portion of the flexible cable 126. FIG. 6b is a partial enlarged view of the structure shown in FIG. 6a. As shown in FIGS. 6a-6b, the output end 127 of the preamplifier 121 connects with partial electrical leads (not numbered) of the FPC 109, and the input end 128 of the preamplifier 121 forms couples of read/write element conductive pads 130. The FPC 109 further has a voltage trace 109b and a ground trace 109a both of which do not connect with the preamplifier 121. The voltage trace 109b connects with a common voltage end 133, which has several micro-actuator voltage conductive pads 131 formed thereon, while the ground trace 109a connects with a common ground end 134, which has several micro-actuator ground conductive pads 132 formed thereon. The tail portion of the flexible cable 126 includes a plurality of read/write electrical leads 136 electrically connecting with the read/write element conductive pads 130, a plurality of micro-actuator voltage traces 137 electrically connecting with the micro-actuator voltage conductive pads 131, and a plurality of micro-actuator ground traces 135 electrically connecting with the micro-actuator ground conductive pads 132. For simplifying the illustration, FIGS. 6a-6b only show one tail portion of the flexible cable 126 connecting with the FPC 109 and the preamplifier 121. In fact, the finished product of the HSA conventionally includes a plurality of HGAs and a plurality of micro-actuators corresponding to the HGAs. Therefore, there are several tail portions of the flexible cables 126 connecting with the sliders and the micro-actuators at one ends and connecting with the FPC and the preamplifier at the other ends.

In the prior art, after the micro-actuator is mounted on the HSA, its performance must be tested to judge if it satisfies the stated demands. However, before the test, all the micro-actuators of the HSA are electrically connected with the FPC and particularly all the electrical leads for controlling the micro-actuators at the tail portions of the flexible cables are connected to the common voltage end 133 and the common ground end 134 in parallel, so it is difficult to test all the micro-actuators' performance at the same time and difficult to judge whether every micro-actuator is eligible, thereby the productive efficiency is low.

In addition, U.S. Pat. No. 6,472,866 disclosed a method for testing the performance of the slider using a testing system with electric probes. The HSA is positioned in a varying magnetic field when tested, and the electric probes are positioned on the metallic pads of the electrical leads connected with the slider. The varying magnetic field generates inductive current in the slider, which runs through the electric probes and then is tested by the testing equipment connecting with the electric probes. Whether the slider is eligible can be judged by analyzing various parameters of the inductive current. The testing method disclosed by the patent can be well applied to test the micro-actuator's performance. When the HSA only has one slider and one micro-actuator used for controlling the position of the slider, the performance test to the micro-actuator can be completed by contacting the electric probes with the micro-actuator voltage trace and the micro-actuator ground trace. However, the testing method can not be implemented to a HSA with a plurality of HGAs and a plurality of corresponding micro-actuators. The reason is one end of each micro-actuator connects to the common voltage trace of the FPC through the micro-actuator voltage trace of the flexible cable, and the other end of the micro-actuator connects to the common ground trace through the micro-actuator ground trace. In other words, all the micro-actuators are parallel connection with the common voltage trace and the common ground trace. When the electric probes contact with any micro-actuator voltage trace and any micro-actuator ground trace, all the micro-actuators are parallelly connected to the testing system, so it is hard to judge which micro-actuator the test result belongs to and hard to judge which micro-actuators are eligible and which micro-actuators are not. That is to say, all the micro-actuators can not be tested respectively.

Hence, it is desired to provide an improved HSA and an improved manufacturing method of the HSA to overcome the shortages of the prior art.

### SUMMARY OF THE INVENTION

Accordingly, an objective of the present invention is to provide an HSA with a structure that makes all the micro-actuators thereof can be tested respectively.

Another objective of the present invention is to provide a method for manufacturing an HSA, which is capable of testing the performance of each micro-actuator of the HSA respectively.

A further objective of the present invention is to provide an FPC which is designed to make the performance of each micro-actuator of an HSA can be tested respectively.

To achieve the above-mentioned objectives, an HSA comprises a plurality of actuator arms, a plurality of HGAs, and an FPC for connecting the HGAs with a printed circuit board of a control system. The HGAs connects with the corresponding actuator arms respectively and are stacked. Each of the HGAs has a slider and a micro-actuator. The FPC comprises a connector for connecting with the printed circuit board, a voltage trace, and a ground trace. One end of the voltage trace connects to the connector and the other end of the voltage trace is a common voltage end. The common voltage end has a plurality of first voltage pads connected thereto and a plurality of second voltage pads arranged adjacent to the corresponding first voltage pads respectively and electrically isolated from the corresponding first voltage pads. Each second voltage pad connects with one of the micro-actuators. One end of the ground trace connects with the connector, and the other end of the ground trace is a common ground end. The common ground end has a plurality of micro-actuator ground pads. Each micro-actuator ground pad connects with one of the micro-actuators. The second voltage pads are electrically connected with the respective first voltage pads after the micro-actuators are tested.

In another embodiment of the HSA according to the present invention, the FPC further comprises a preamplifier formed at an end thereof opposite the connector and preamplifier electrical leads. The preamplifier has an output end and an input end. The input end has a plurality of sets of read/write element pads, each set of the read/write element pads connects to one of the sliders. One end of the preamplifier electrical lead connects with the connector and the other end of the preamplifier electrical lead connects with the output end of the preamplifier.

According to another embodiment of the HSA of the present invention, the first voltage pads and the corresponding second voltage pads are electrically connected with each other by electrical leads, laser welding, anisotropic conductive film, or electrical wire connection. Selectively, the first voltage pads and the corresponding second voltage pads are electrically connected with each other using golden balls, solder balls, silver epoxy balls, or solder paste. In addition, epoxy or resin is disposed between the first voltage pads and the second voltage pads to protect the electrical connection of the first voltage pads and the second voltage pads.

A manufacturing method for a HSA according to the present invention comprises the steps of: (1) providing a plurality of actuator arms and a plurality of HGAs each of which has a slider and a micro-actuator, and assembling the actuator arms with the corresponding HGAs; (2) providing an FPC, the FPC comprising: a connector for connecting with a printed circuit board; a voltage trace, one end of the voltage trace connecting to the connector and the other end of the voltage trace being a common voltage end, the common voltage end having a plurality of first voltage pads connected thereto and a plurality of second voltage pads arranged adjacent to the corresponding first voltage pads respectively and electrically isolated from the respective first voltage pads; and a ground trace, one end of the ground trace connecting with the connector, and the other end of the ground trace being a common ground end, the common ground end having a plurality of micro-actuator ground pads; (3) electrically connecting the second voltage pads and the micro-actuator ground pads with the corresponding micro-actuators respectively; (4) testing the micro-actuators through the second voltage pads and the micro-actuator ground pads; and (5) electrically connecting the second voltage pads with the corresponding first voltage pads.

In an embodiment of the manufacturing method according to the present invention, testing the micro-actuators comprises the steps of: (a) providing a testing system with at least two testing probes; and (b) electrically contacting one of the testing probes of the testing system with the micro-actuator ground pad and electrically contacting the other testing probe with the second voltage pad to obtain testing data.

In another embodiment of the manufacturing method of a HSA according to the present invention, the testing system further comprises at least one base and a pair of movable load beams positioned on the base. The at least two testing probes are mounted on ends of the pair of load beams.

In still another embodiment of the manufacturing method of a HSA according to the present invention, the FPC further comprises a preamplifier formed at an end thereof opposite the connector and preamplifier electrical leads. The preamplifier has an output end and an input end having a plurality of sets of read/write element pads. One end of the preamplifier electrical lead connects with the connector and the other end of the preamplifier electrical lead connects with the output end of the preamplifier. The manufacturing method further comprises electrically connecting the plurality of sets of read/write element pads with the corresponding sliders respectively; and testing the sliders through the read/write element pads.

The FPC of the present invention adapted for connecting a set of stacked HGAs with a printed circuit board of a control system comprises a connector for connecting with the printed circuit board, a voltage trace, and a ground trace. One end of the voltage trace connects to the connector and the other end is a common voltage end. The common voltage end has a plurality of first voltage pads and a plurality of second voltage pads arranged adjacent to the corresponding first voltage pads respectively and electrically isolated from the respective first voltage pads. Each of the second voltage pads is adapted to connect with the micro-actuator of the corresponding head gimbal assembly. One end of the ground trace connects with the connector and the other end of the ground trace is a common ground end. The common ground end has a plurality of micro-actuator ground pads. Each of the micro-actuator ground pads is adapted to connect with one of the micro-actuator of the corresponding head gimbal assembly.

In comparison with the prior art, the FPC of the HSA of the present invention provides a plurality of first voltage pads and a plurality of second voltage pads electrically isolated from the respective first voltage pads. When the micro-actuator is being tested, the second voltage pads connect with the corresponding micro-actuator and disconnect with the first voltage pads, that is to say, the second voltage pads electrically disconnect with the common voltage trace and, in turn, the micro-actuators are independent with each other, thereby the performance of each micro-actuator can be obtained by testing each micro-actuator individually. This is different from and much advantageous over the prior art, in which all the micro-actuators are parallelly connected with each other during testing that causes the testing result can not be judged which micro-actuator it belongs to.

Other aspects, features, and advantages of this invention will become apparent from the following detailed description when taken in conjunction with the accompanying drawings, which are a part of this disclosure and illustrate, by way of example, principles of this invention.

### BRIEF DESCRIPTION OF THE DRAWINGS

The accompanying drawings facilitate an understanding of the various embodiments of this invention. In such drawings:

FIG. 1 is a perspective view of a conventional disk drive unit;

FIG. 2 is a perspective view of a HSA of the disk drive unit shown in FIG. 1;

FIG. 3 is a perspective view of a HGA of the HSA shown in FIG. 2;

FIG. 4 is a partially enlarged perspective view of the HGA shown in FIG. 3;

FIG. 5 shows a flexible cable connecting with the HGA shown in FIG. 3;

FIG. 6a partially illustrates the connection relation of an FPC of the HSA shown in FIG. 2, a preamplifier of the FPC and the flexible cable;

FIG. 6b is a partially enlarged view of the structure shown in FIG. 6a, illustrating the connection relation between the leads in the flexible cable and the FPC and the preamplifier;

FIG. 7 is a perspective view of an HSA according to an embodiment of the present invention;

FIG. 8a is a perspective view of an HGA of the HSA shown in FIG. 7;

FIG. 8b is a partially enlarged view of the HGA shown in FIG. 8a;

FIG. 8c shows a flexible cable connecting with the HGA shown in FIG. 8a;

FIG. 9a is a partially enlarged view of an FPC of the HSA shown in FIG. 7, illustrating the FPC's preamplifier, voltage trace and ground trace;

FIG. 9b illustrates the connection relation of the FPC, the preamplifier and the flexible cables of the HSA shown in FIG. 7;

FIG. 9c is a partially enlarged view of the structure shown in FIG. 9b, illustrating the connection relation between the leads in the flexible cables and the FPC and the preamplifier;

FIG. 10 is a flow chart illustrating a manufacturing method of the HSA according to an embodiment of the present invention;

FIG. 11 is a perspective view of a testing system used in the manufacturing method of the HSA of the present invention;

FIG. 12 shows a state that the micro-actuator is being tested by the testing system shown in FIG. 11;

FIG. 13a is a schematic view of a first embodiment of the connection way between a first voltage pad and a second voltage pad of the FPC of the present invention;

FIG. 13b is a schematic view of a second embodiment of the connection way between a first voltage pad and a second voltage pad of the FPC of the present invention;

FIG. 13c is a schematic view of a third embodiment of the connection way between a first voltage pad and a second voltage pad of the FPC of the present invention;

FIG. 13d is a schematic view of a fourth embodiment of the connection way between a first voltage pad and a second voltage pad of the FPC of the present invention;

FIG. 14 is a flow chart of a manufacturing method of the HSA according to another embodiment of the present invention; and

FIG. 15 is a flow chart of a manufacturing method of the HSA according to still another embodiment of the present invention.

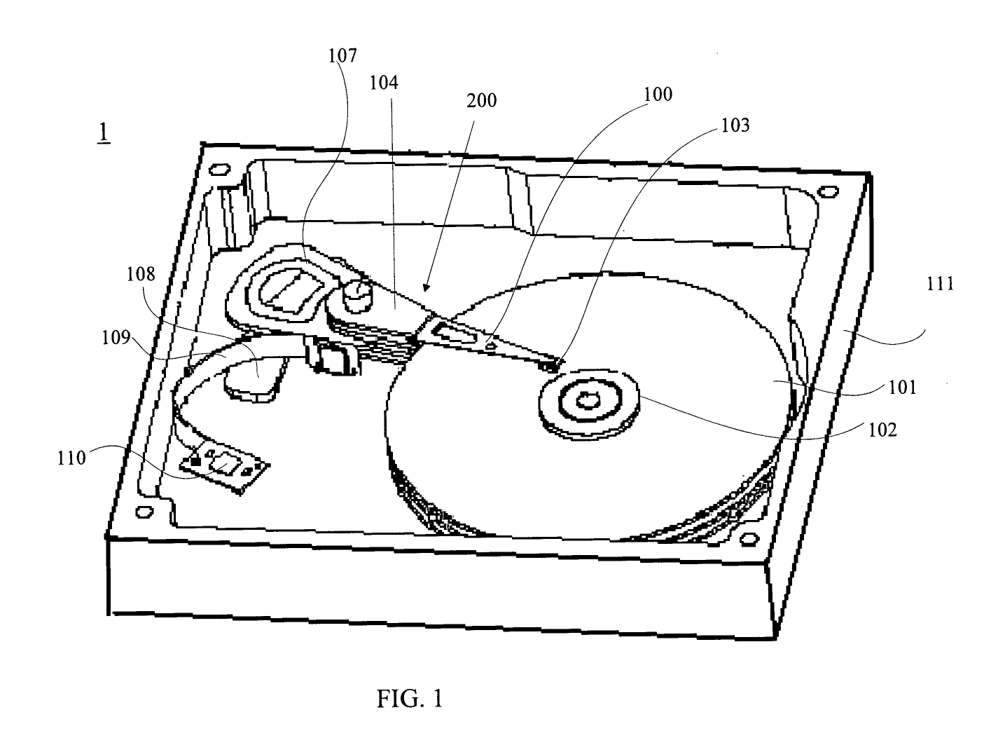

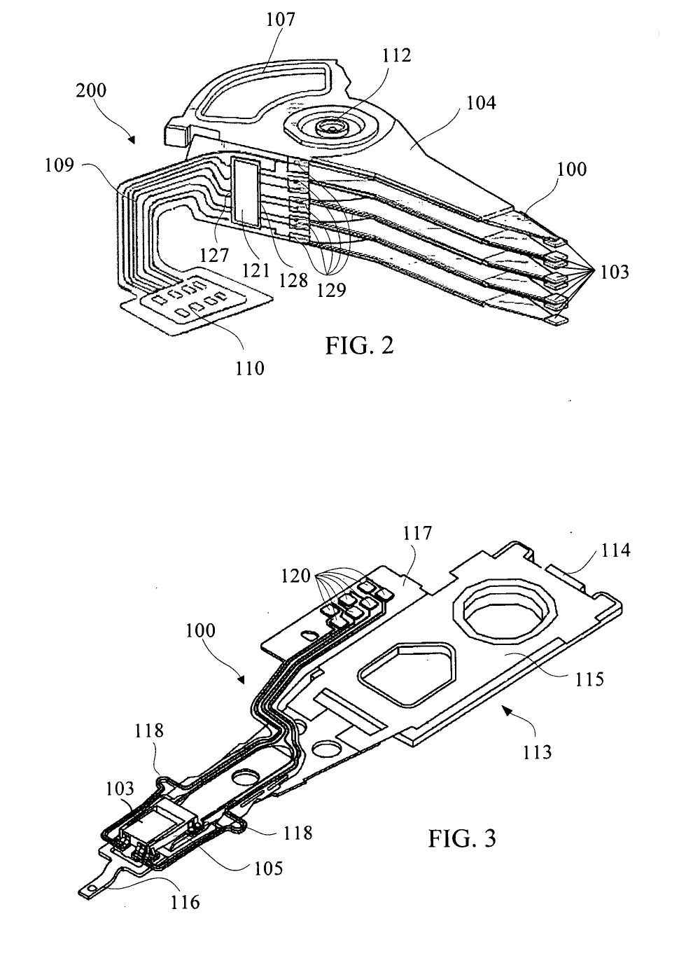

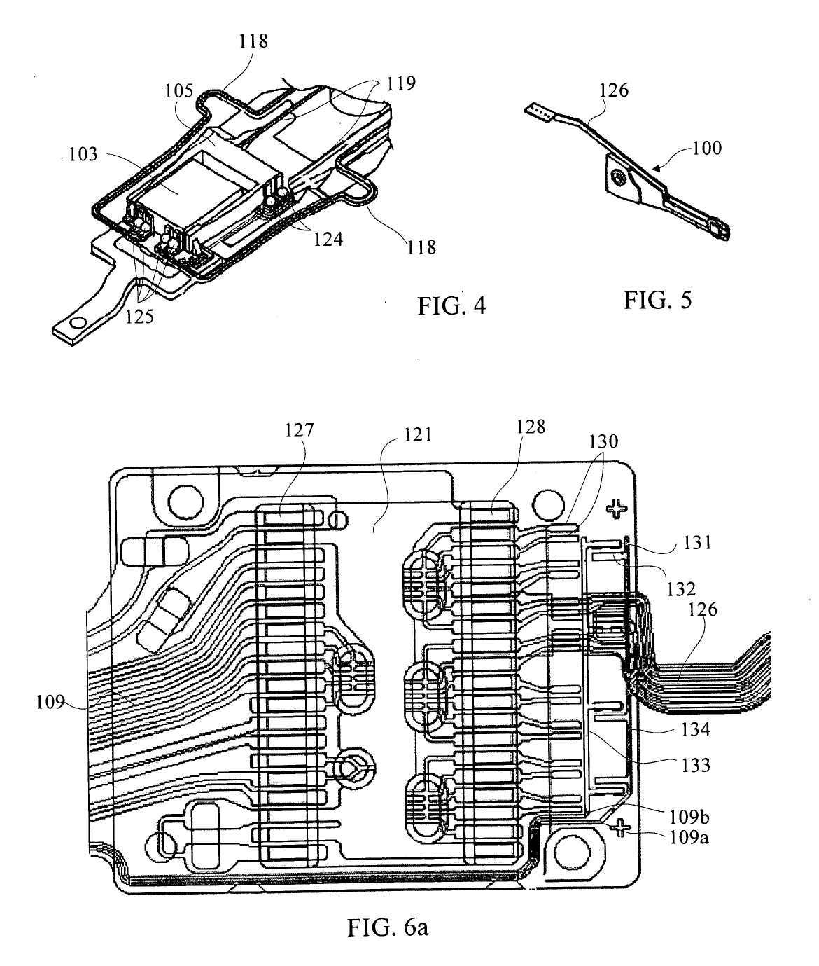

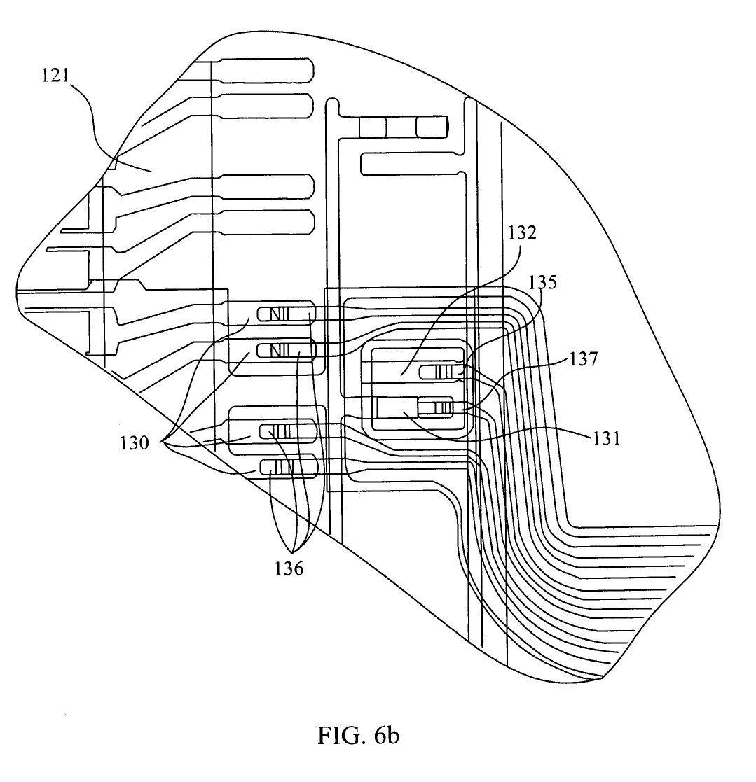

### DETAILED DESCRIPTION OF ILLUSTRATED EMBODIMENTS

Various preferred embodiments of the invention will now be described with reference to the figures, wherein like reference numerals designate similar parts throughout the various views.

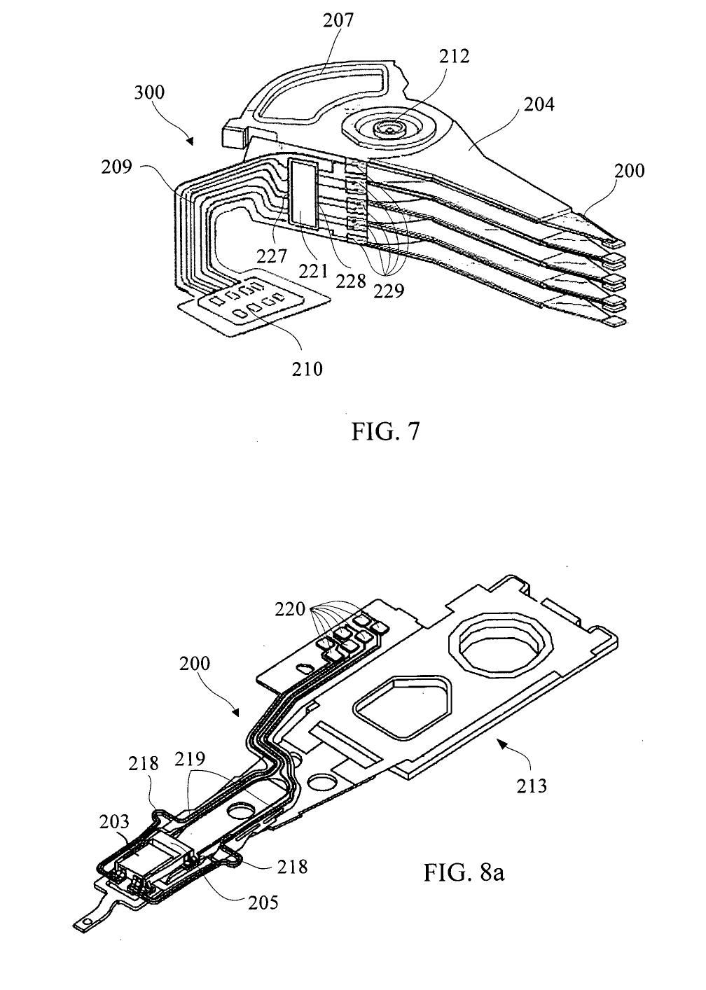

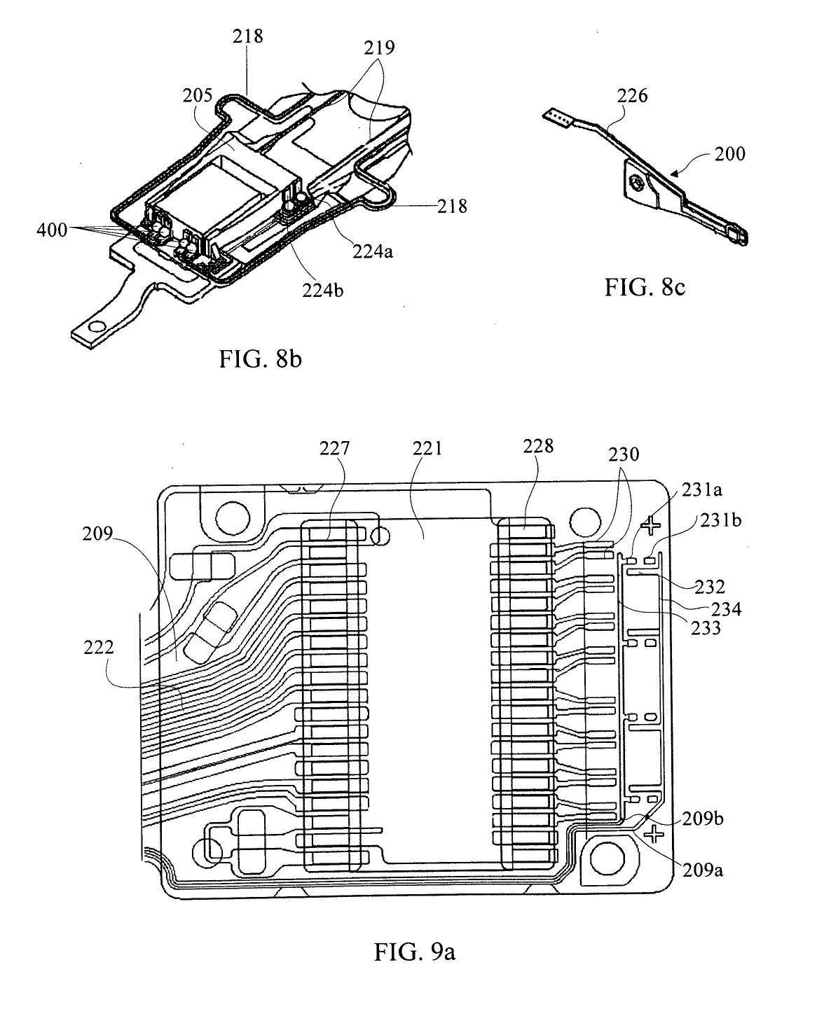

Firstly, embodiments of HSAs according to the present invention are described. As shown in FIG. 7, an HSA 300 according to one embodiment of the present invention includes a plurality of HGAs 200, such as five HGAs 200, a plurality of actuator arms 204 corresponding to the HGAs 200, a fantail voice coil 207 and a FPC 209 adapted to connect the HGAs with a printed circuit board (not shown) of a control system of a disk drive unit. The actuator arms 204 are stacked and connected with the fantail voice coil 207 by a secure means, such as a bearing 212, so as to stack the HGAs 200. The FPC 209 provides a connector 210 for connecting with the printed circuit board at one end thereof. The FPC 209 is connected to the control system by connecting the connector 210 with the printed circuit board. The other end 229 of the FPC 209 opposite the connector 210 electrically connect with the HGAs 200 through the corresponding flexible cables 226 (referring to FIG. 8c), in turn, the control system of the disk drive unit connects with all the HGAs 200 through the FPC 209 and the flexible cables 226, thereby controls the HGAs 200.

As shown in FIGS. 8a-8b, each HGA 200 includes a suspension 213 which carries a slider 203 at the top end thereof and a micro-actuator 205 for fine tuning the slider's position. The micro-actuator 205 has a voltage end 224a and a ground end 224b, both of which electrically connect with the inner suspension traces 219 of the suspension 213. The slider 203 electrically connects with the outer suspension traces 218 of the suspension 213 through several electrical bonding balls 400, such as golden bonding balls (GBB) or solder bonding balls (SBB). The other ends of the inner suspension traces 219 and the outer suspension traces 218 simultaneously connect with the corresponding pads 220 at the tail end of the suspension 213. Referring to FIG. 7 and FIG. 8c simultaneously, the pads 220 also connect with the front portion of the flexible cables 226, and the tail portion of the flexible cables 226 electrically connect with the other end 229 of the FPC 209 such that the micro-actuator 205 and the slider 203 connect with the FPC 209 through the inner and outer suspension traces 219, 218 and the flexible cable 226.

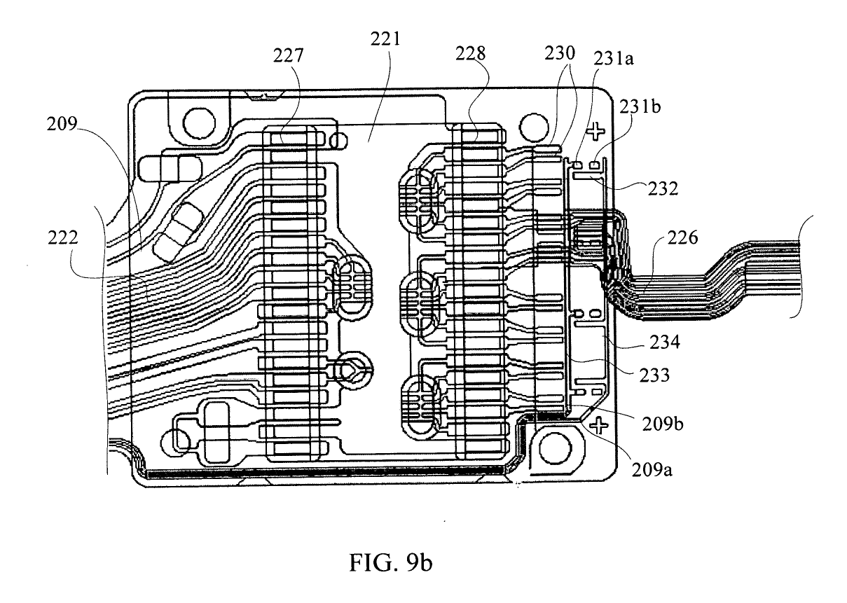

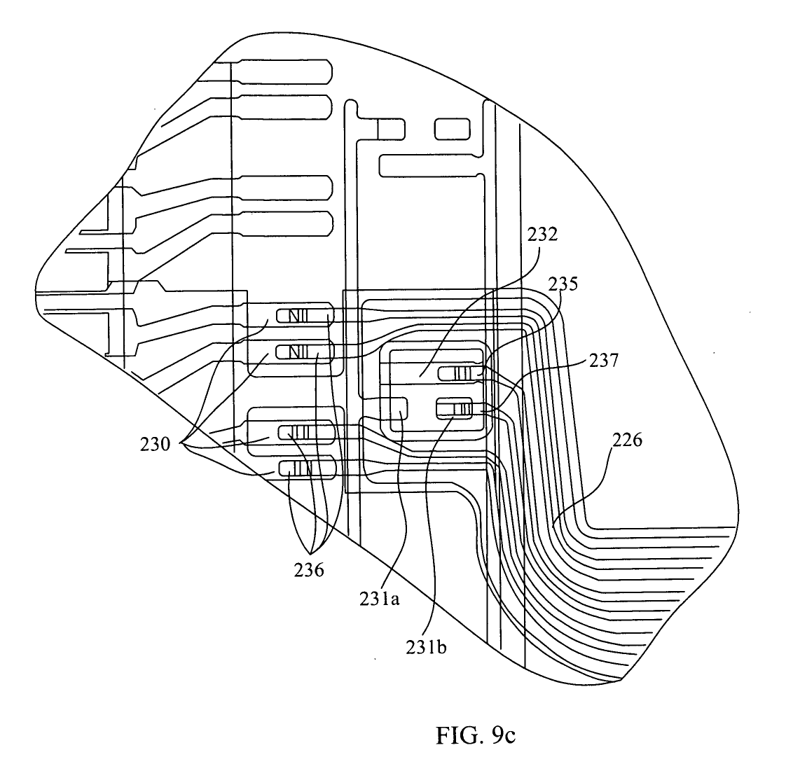

FIG. 9a is a partially enlarged view of the FPC 209 of the HSA shown in FIG. 7 and illustrates the FPC's 209 preamplifier 221, voltage trace 209b and ground trace 209a in detail. FIG. 9b shows the connection relation of the FPC 209, the preamplifier 221 and the flexible cable 226 of the HSA shown in FIG. 7. FIG. 9c is a partially enlarged view of the structure shown in FIG. 9b, illustrating the connection relation of the conductor in the flexible cable 226 and the FPC 209 and the preamplifier 221. Concretely, as shown in FIGS. 9a-9c, except the connector 210, the FPC 209 further includes a preamplifier 221 formed at an end thereof opposite the connector 210, preamplifier electrical leads 222, a voltage trace 209b and a ground trace 209a. The preamplifier 221 has an output end 227 and an input end 228. The preamplifier electrical lead 222 connects with the connector 220 at one end thereof and connects with the output end 227 of the preamplifier 221 at the other end, that is to say, the output end 227 of the preamplifier 221 connects with the connector 210 through the preamplifier electrical lead 222. The input end 228 of the preamplifier 221 has a plurality of sets of read/write element pads 230, each set of which connect with a slider 203. The voltage trace 209b and the ground trace 209a of the FPC 209 are disconnected with the preamplifier 221. Concretely, one end of the voltage trace 209b connects with the connector 210, and the other end is a common voltage end 233 having a plurality of first voltage pads 231a and a plurality of second voltage pads 231b. One end of the ground trace 209a connects with the connector 210, and the other end is a common ground end 234 having a plurality of micro-actuator ground pads 232 arranged adjacent to the corresponding first voltage pads 231a respectively and electrically isolated from the respective first voltage pads 231a. Each of the second voltage pad 230 is adapted to connect with one micro-actuator 205 of the corresponding HGA 200. The flexible cable 226 includes a plurality of, such as four read/write element traces 236 electrically connecting with the corresponding read/write element pads 230. The read/write element traces 236 electrically connect with the electrical pads of the slider 203, in turn, the read/write element pads 230 connect with the slider 203. The flexible cable 226 further includes a micro-actuator trace 237 which connects with the second voltage pad 231b and electrically connects with the micro-actuator voltage end 224a, and a micro-actuator ground trace 235 which connects with the micro-actuator ground pad 231a and electrically connects with the micro-actuator ground end 224b. Accordingly, the second voltage pad 231b and the micro-actuator ground pad 232 are connected with the micro-actuator 205.

Since the second voltage pads 231b electrically connect with the respective micro-actuators and electrically isolate from the first voltage pads 231a, the second voltage pads 231b are not connected with the voltage trace 209b before the HSA 300 is assembled, that is to say, the micro-actuators 205 and the voltage trace 209b are disconnection such that the micro-actuators 205 are independent from each other, therefore, all the micro-actuators can be tested respectively to obtain the performance of every micro-actuator. After all the micro-actuators are tested, connect the second voltage pads 231b with the respective first voltage pads 231a, namely connect the micro-actuators 205 with the voltage trace 209b so that the control system can control the micro-actuators 205.

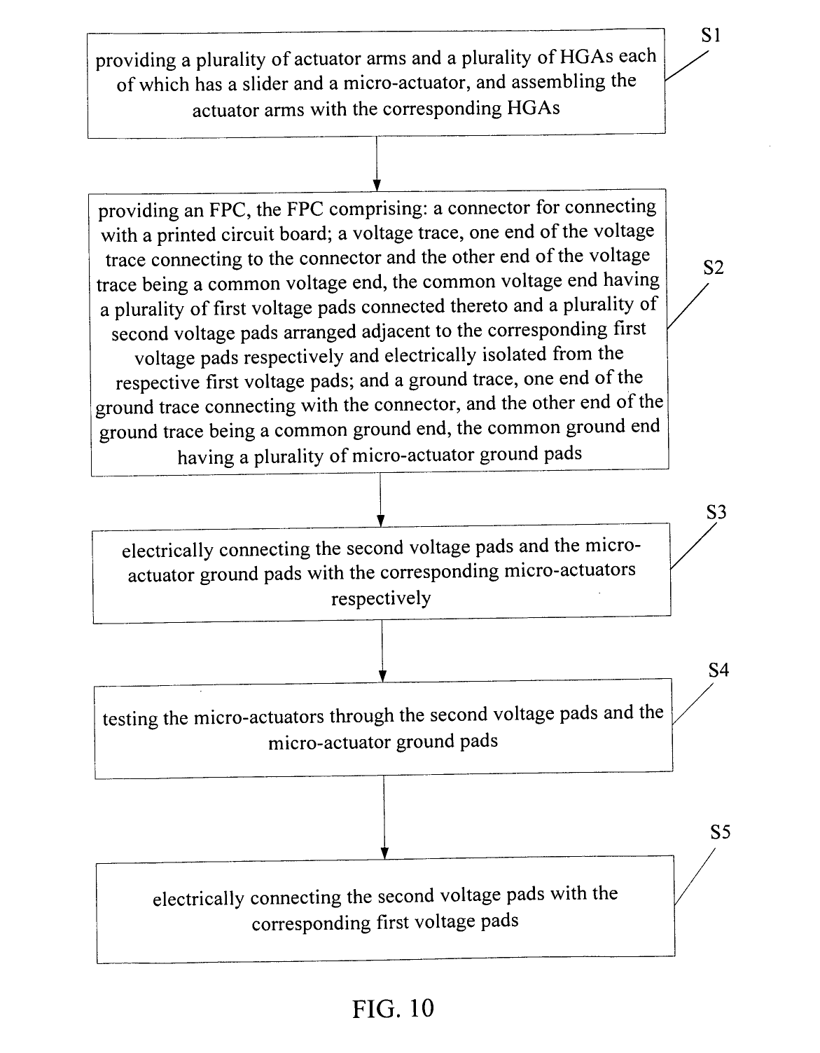

Now embodiments of the manufacturing methods of the HSA according to the present invention are described. FIG. 10 is a flow chart of the manufacturing method of the HSA according to one embodiment of the present invention. As shown in the figure, the manufacturing method includes the following steps: (1) providing a plurality of actuator arms and a plurality of HGAs each of which has a slider and a micro-actuator, and assembling the actuator arms with the corresponding HGAs, which is step S1; (2) providing an FPC, the FPC comprising a connector for connecting with a printed circuit board; a voltage trace, one end of the voltage trace connecting to the connector and the other end of the voltage trace being a common voltage end, the common voltage end having a plurality of first voltage pads connected thereto and a plurality of second voltage pads arranged adjacent to the corresponding first voltage pads respectively and electrically isolated from the respective first voltage pads; and a ground trace, one end of the ground trace connecting with the connector, and the other end of the ground trace being a common ground end, the common ground end having a plurality of micro-actuator ground pads, which is step S2; (3) electrically connecting the second voltage pads and the micro-actuator ground pads with the corresponding micro-actuators respectively, which is step S3; (4) testing the micro-actuators through the second voltage pads and the micro-actuator ground pads, which is step S4; and (5) electrically connecting the second voltage pads and the corresponding first voltage pads, which is step S5.

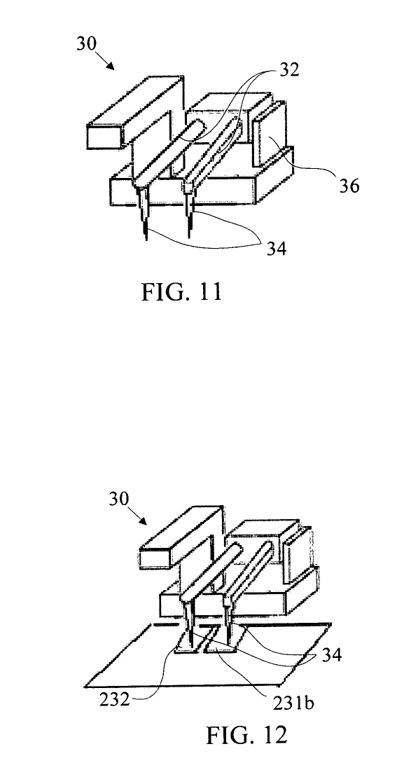

In one embodiment of the present invention, the testing in the step S2 further includes (a) providing a testing system with at least two testing probe; and (b) obtaining testing data by electrically contacting a testing probe of the testing system with the micro-actuator ground pad and contacting the other testing probe with the second voltage pads. The testing system can be the testing system 30 shown in FIG. 11. As shown in FIG. 11, the testing system 30 includes at least a base 36 carrying a pair of movable load beams 32 with testing probes 34 mounted at ends thereof. The testing system further includes a testing circuit (not shown) for recording the testing results which connects with the testing probes 34. When the testing is carried out, as shown in FIG. 12, put one of the probes 34 on the micro-actuator ground pad 232 and put the other probe 34 on the second voltage pad 231b connected with the voltage end of the micro-actuator to judge whether there is a current in the micro-actuator so as to test the micro-actuator. In the present invention, the testing system 30 can have several pairs of probes and corresponding circuits so that it can test several micro-actuators simultaneously.

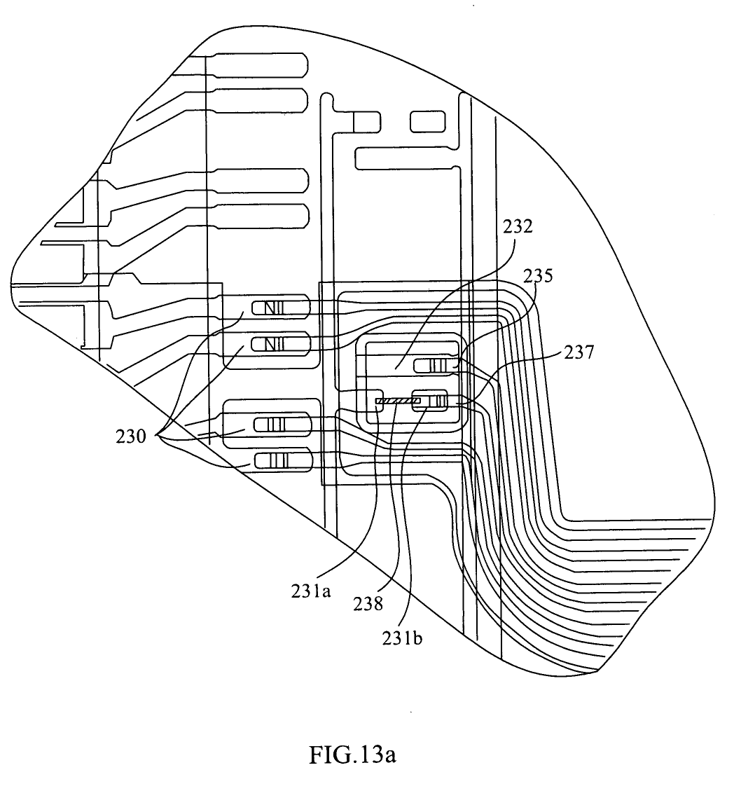

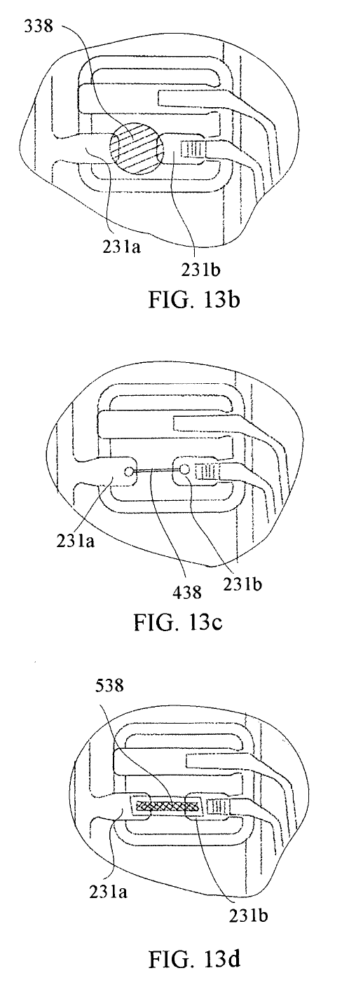

In the present invention, in the step S5, the second voltage pads and the corresponding first voltage pads can be electrically connected by any suitable electrical connection way. In one embodiment of the present invention, as shown in FIG. 13a, the first voltage pad 213a and the corresponding second voltage pad 213b are electrically connected with each other by an electrical lead 238.

In another embodiment of the present invention, as shown in FIG. 13b, the first voltage pad 213a and the corresponding second voltage pad 213b are electrically connected with each other by an electrical bonding ball 338, which can be a golden ball, a solder ball, silver epoxy, or solder paste and so on.

In another embodiment of the present invention, as shown in FIG. 13c, the first voltage pad 213a and the corresponding second voltage pad 213b are electrically connected with each other by an electrical wire 438, namely using a wire connection method.

In further another embodiment of the present invention, as shown in FIG. 13d, the first voltage pad 213a and the corresponding second voltage pad 213b are electrically connected with each other by anisotropic conductive film (ACF) 538.

In still another embodiment of the present invention, the first voltage pad 213a and the corresponding second voltage pad 213b are electrically connected with each other by laser welding.

In addition, besides the above-mentioned electrical connection ways used to connect the first voltage pads 231a and the second voltage pads 231b, epoxy or resin are disposed between the first voltage pads 231a and second voltage pads 231b to protect the electrical connection therebetween.

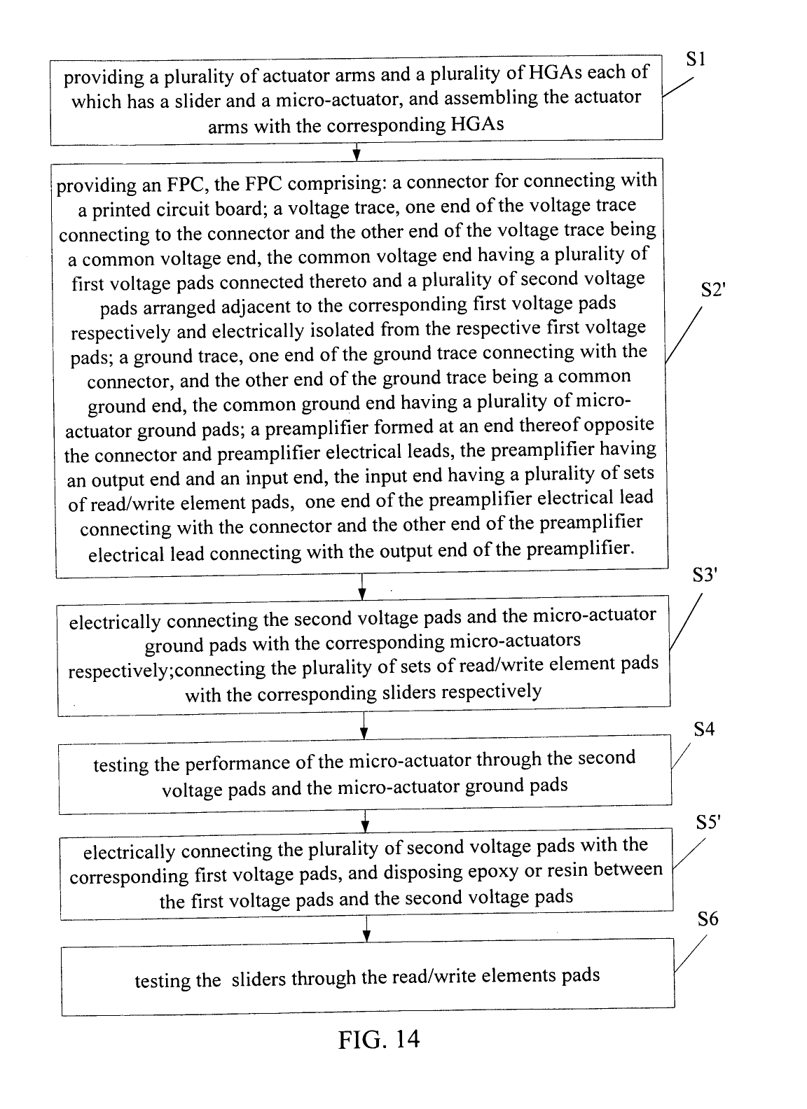

FIG. 14 is a flow chart of a manufacturing method of the HSA according to another embodiment of the present invention. In comparison with the embodiment shown in FIG. 10, the differences are as followed: in the step S2, the FPC further includes a preamplifier formed at an end thereof opposite the connector and preamplifier electrical leads, the preamplifier has an output end and an input end having a plurality of sets of read/write element pads, one end of the preamplifier electrical lead connects with the connector and the other end of the preamplifier electrical lead connects with the output end of the preamplifier, which is the step S2′; the step S3 further includes connecting the plurality of sets of read/write element pads with the corresponding sliders respectively, which is the step S3′; the step S5 further includes disposing epoxy or resin between the first voltage pads and the second voltage pads to protect the electrical connection of the first voltage pads and the second voltage pads, which is step S5′; in addition, the method further includes step S6: testing the sliders through the read/write element pads, the testing method and testing system is the same as before.

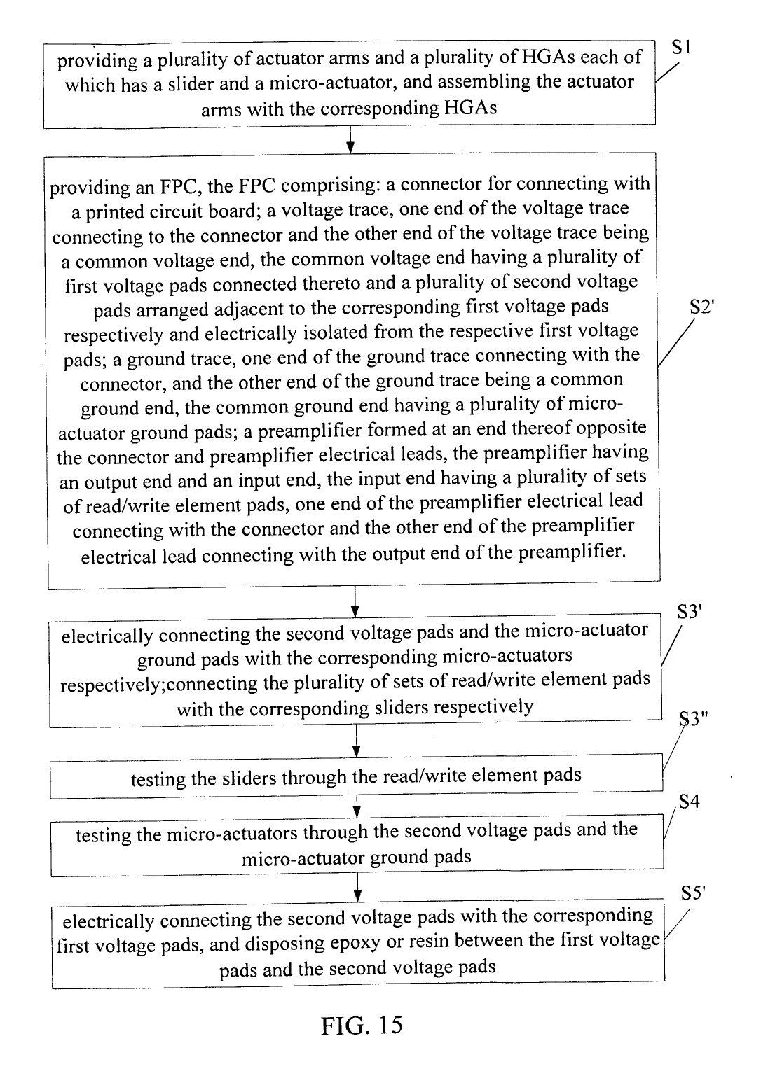

FIG. 15 is a flow chart of a manufacturing method of the HSA according to still another embodiment of the present invention. In comparison with the embodiment shown in FIG. 14, the difference is that testing the sliders with the read/write element pads is implemented after the step S3′ and before the step S4.

It can be seen from the manufacturing method of the embodiment above-mentioned that when the micro-actuator is being tested, the second voltage pads 231b are electrically isolated from the first voltage pads 231a, that is to say, the second voltage pads 231b and the voltage traces 209 are disconnection, namely the micro-actuators 205 and the voltage lines 209 are disconnection, in turn, the micro-actuators are independent with each other, thereby the performance of each micro-actuator can be obtained by testing the micro-actuators individually. This is different from and much advantageous over the prior art, in which all the micro-actuators are parallelly connected during testing that causes the testing result can not be judged which micro-actuator it belongs to.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A head stack assembly, comprising:
a plurality of actuator arms;
a plurality of head gimbal assemblies connecting with the corresponding actuator arms and being stacked, each of the head gimbal assemblies having a slider and a micro-actuator; and
a flexible printed cable for connecting the head gimbal assemblies with a printed circuit board of a control system, the flexible printed cable comprising:
a connector for connecting with the printed circuit board;
a voltage trace, one end of the voltage trace connecting to the connector, and the other end of the voltage trace being a common voltage end, the common voltage end having a plurality of first voltage pads connected thereto and a plurality of second voltage pads arranged adjacent to the corresponding first voltage pads respectively and electrically isolated from the respective first voltage pads, each second voltage pad connecting with one of the micro-actuators; and
a ground trace, one end of the ground trace connecting with the connector, and the other end of the ground trace being a common ground end, the common ground end having a plurality of micro-actuator ground pads, each micro-actuator ground pad connecting with one of the micro-actuators;
wherein the second voltage pads are electrically connected with the respective first voltage pads after the micro-actuators are tested.

2. The head stack assembly as claimed in claim 1, wherein the flexible printed cable further comprises a preamplifier formed at an end thereof opposite the connector and preamplifier electrical leads, the preamplifier has an output end and an input end, the input end has a plurality of sets of read/write element pads, each set of the read/write element pads connect to one of the sliders, one end of the preamplifier electrical lead connects with the connector and the other end of the preamplifier electrical lead connects with the output end of the preamplifier.

3. The head stack assembly as claimed in claim 1, wherein the first voltage pads and the corresponding second voltage pads are electrically connected with each other by electrical leads, laser welding, anisotropic conductive film, or electrical wire connection.

4. The head stack assembly as claimed in claim 1, wherein the first voltage pads and the corresponding second voltage pads are electrically connected with each other using golden balls, solder balls, silver epoxy balls, or solder paste.

5. The head stack assembly as claimed in claim 1, wherein epoxy or resin is disposed between the first voltage pads and the second voltage pads to protect the electrical connection of the first voltage pads and the second voltage pads.

6. A method for manufacturing a head stack assembly comprising the steps of:
(1) providing a plurality of actuator arms and a plurality of head gimbal assemblies each of which has a slider and a micro-actuator, and assembling the actuator arms with the corresponding head gimbal assemblies;
(2) providing a flexible printed cable, the flexible printed cable comprising:
a connector for connecting with a printed circuit board;
a voltage trace, one end of the voltage trace connecting to the connector, and the other end of the voltage trace being a common voltage end, the common voltage end having a plurality of first voltage pads connected thereto and a plurality of second voltage pads arranged adjacent to the corresponding first voltage pads respectively and electrically isolated from the respective first voltage pads; and
a ground trace, one end of the ground trace connecting with the connector, and the other end of the ground trace being a common ground end, the common ground end having a plurality of micro-actuator ground pads;
(3) electrically connecting the second voltage pads and the micro-actuator ground pads with the corresponding micro-actuators respectively;
(4) testing the micro-actuators through the second voltage pads and the micro-actuator ground pads; and
(5) electrically connecting the second voltage pads with the corresponding first voltage pads.

7. The method as claimed in claim 6, wherein the step (4) further comprises:
(a) providing a testing system with at least two testing probes; and
(b) electrically contacting one of the testing probes of the testing system with the micro-actuator ground pad and electrically contacting the other testing probe with the second voltage pad to obtain testing data.

8. The method as claimed in claim 7, wherein the testing system further comprises at least one base and a pair of movable load beams positioned on the base, the at least two testing probes are mounted on ends of the pair of load beams.

9. The method as claimed in claim 6, wherein in the step (5) the first voltage pads and the corresponding second voltage pads are electrically connected with each other by electrical leads, laser welding, anisotropic conductive film, or electrical wire connection.

10. The method as claimed in claim 6, wherein in the step (5) the first voltage pads and the corresponding second voltage pads are electrically connected with each other using golden balls, solder balls, silver epoxy balls, or solder paste.

11. The method as claimed in claim 6, further comprising step (6): disposing epoxy or resin between the first voltage pads and the second voltage pads to protect the electrical connection of the first voltage pads and the second voltage pads.

12. The method as claimed in claim 6, wherein the flexible printed cable further comprises a preamplifier formed at an end thereof opposite the connector and preamplifier electrical leads, the preamplifier has an output end and an input end having a plurality of sets of read/write element pads, one end of the preamplifier electrical lead connects with the connector and the other end of the preamplifier electrical lead connects with the output end of the preamplifier, the method further comprises:
electrically connecting the plurality of sets of read/write element pads with the corresponding sliders respectively; and
testing the sliders through the read/write element pads.

13. A flexible printed cable adapted for connecting a set of stacked head gimbal assemblies with a printed circuit board of a control system wherein each of the head gimbal assemblies has a slider and a micro-actuator, the flexible printed cable comprising:
a connector for connecting with the printed circuit board;
a voltage trace, one end of the voltage trace connecting to the connector, and the other end of the voltage trace being a common voltage end, the common voltage end having a plurality of first voltage pads connected thereto and a plurality of second voltage pads arranged adjacent to the corresponding first voltage pads respectively and electrically isolated from the respective first voltage pads, each of the second voltage pads being adapted to connect with the micro-actuator of the corresponding head gimbal assembly; and
a ground trace, one end of the ground trace connecting with the connector, and the other end of the ground trace being a common ground end, the common ground end having a plurality of micro-actuator ground pads, each of micro-actuator ground pads being adapted to connect with the micro-actuator of the corresponding head gimbal assembly.

14. The flexible printed cable as claimed in claim 13, further comprising a preamplifier formed at an end thereof opposite the connector and preamplifier electrical leads, the preamplifier has an output end and an input end, the input end has a plurality of sets of read/write element pads, each set of read/write element pads connect to one of the sliders, one end of the preamplifier electrical lead connects with the connector and the other end of the preamplifier electrical lead connects with the output end of the preamplifier.
